(19) United States
(12) Patent Application Publication
(10) Pub. No.: US 2022/0206596 A1
(43) Pub. Date: Jun. 30, 2022

(54) Mouse Finger Rest

(71) Applicant: Robert Rutledge, Elizabeth City, NC (US)

(72) Inventor: Robert Rutledge, Elizabeth City, NC (US)

(21) Appl. No.: 17/538,188

(22) Filed: Nov. 30, 2021

Related U.S. Application Data
(60) Provisional application No. 63/131,494, filed on Dec. 29, 2020.

(51) Int. Cl. G06F 3/0354

(52) U.S. Cl. CPC G06F 3/03543

(57) ABSTRACT

A mouse finger rest is provided. The device includes a finger support having a lower leg and an upper platform, wherein the upper platform is rigidly affixed to the lower leg at an angle to rest substantially parallel to an upper portion of a mouse. The lower leg is disposed along a bracket, wherein a first end of the bracket and a second end of the bracket are removably securable to a front portion of a base of the mouse. In some embodiments, a protrusion extends perpendicularly from the lower end of the lower leg, wherein the protrusion is slidably disposed within a track disposed in a front portion of the base of the mouse.

### CROSS REFERENCE TO RELATED APPLICATIONS

This application claims the benefit of U.S. Provisional Application No. 63/131,494 filed on Dec. 29, 2020. The above identified patent application is herein incorporated by reference in its entirety to provide continuity of disclosure.

### BACKGROUND OF THE INVENTION

The present invention relates to finger rests. More particularly, the present invention pertains to a finger rest slidably movable along a mouse to provide support to a user's finger to prevent accidental actuation of mouse buttons.

Many individuals use computers regularly throughout the day which often require constant usage of a mouse. However, prolonged use of a mouse can result in discomfort throughout the user's wrist, forearm, shoulder, and fingers as the user's hand is maintained in a partially raised position throughout the day. Continual mouse usage can also result in painful medical conditions such as carpal tunnel syndrome as a result of a user being unable to comfortably rest their hand while using the mouse. Such conditions can be frustrating and costly to properly treat.

Additionally, many traditional mouses have sensitive buttons, often resulting in individuals inadvertently actuating the mouse buttons by virtue of resting their fingers on the mouse buttons. Unintentionally actuating a mouse button can lead to interruptions in the user's workflow, requiring added time to close context menus or correct mistakes caused by the unintended click. Furthermore, many individuals using precise software relying on detailed cursor control, such as computer aided drawing or other design software, may wish to disable mouse buttons to prevent unintended actuation as the mouse is gripped to provide precise cursor control. Therefore, a device that can prevent unintended mouse clicks while also providing a resting location for a user's fingers to reduce strain is desired.

In light of the devices disclosed in the known art, it is submitted that the present invention substantially diverges in design elements from the known art and consequently it is clear that there is a need in the art for an improvement to existing finger rests. In this regard, the instant invention substantially fulfills these needs.

### SUMMARY OF THE INVENTION

In view of the foregoing disadvantages inherent in the known types of finger rests now present in the known art, the present invention provides a slidable mouse finger rest wherein the same can be utilized for providing convenience for the user when supporting a user's finger above either the left or right mouse buttons as desired to prevent unintended actuation of the mouse buttons.

The present system comprises a finger support having a lower leg and an upper platform, wherein the upper platform is rigidly affixed to the lower leg at an angle to rest substantially parallel to an upper portion of a mouse. The lower leg is disposed along a bracket, wherein a first end of the bracket and a second end of the bracket are removably securable to a front portion of a base of the mouse. In some embodiments, a protrusion extends perpendicularly from a lower end of the lower leg, wherein the protrusion is slidably disposed within a track disposed in a front portion of the base of the mouse.

In some embodiments, a pair of apertures are disposed through the first end and the second end of the bracket, wherein the apertures are dimensioned to receive fasteners therethrough. In another embodiment, the fasteners removably secure the bracket to corresponding apertures disposed within the base of the mouse. In other embodiments, a depression is disposed within an upper surface of the upper platform, wherein the depression is dimensioned to contour to a fingertip. In yet another embodiment, the depression extends through a front end of the upper platform, such that the front end comprises a height less than that of a rear end of the upper platform. In some embodiments, the first end and the second end of the bracket are offset from a central portion of the bracket, such that a gap is defined between the front portion of the mouse and the central portion. In another embodiment, the first and second ends are offset via a pair of extensions disposed perpendicularly to each of the central portion and the first and second ends. In other embodiments, a loop is affixed to a lower end of the lower leg, wherein the loop is slidably disposed about the bracket. In yet another embodiment, the loop is dimensioned to frictionally engage the bracket, such that a position of the finger support is retained in a desired position. In some embodiments, wherein the angle is equivalent to a slope of the upper portion of the mouse, such that the upper platform rests parallel to a button of the mouse. In another embodiment, the bracket comprises an arcuate central portion. In other embodiments, a length of the lower leg maintains the upper platform in an elevated state above the upper portion of the mouse. In yet another embodiment, a textured covering is removably securable over the finger support. In some embodiments, the protrusion comprises a distal end having a height greater than a height of a track aperture.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows an exploded view of an embodiment of the mouse finger rest.

FIG. 18 shows an exploded view of an alternate embodiment of the mouse finger rest.

FIG. 2 shows a close-up view of a depression of an embodiment of the mouse finger rest.

FIG. 3 shows a side view of an embodiment of the mouse finger rest affixed to a mouse.

FIG. 4 shows a perspective view of an embodiment of the mouse finger rest in use.

### DETAILED DESCRIPTION OF THE INVENTION

Reference is made herein to the attached drawings. Like reference numerals are used throughout the drawings to depict like or similar elements of the mouse finger rest. The figures are intended for representative purposes only and should not be considered to be limiting in any respect.

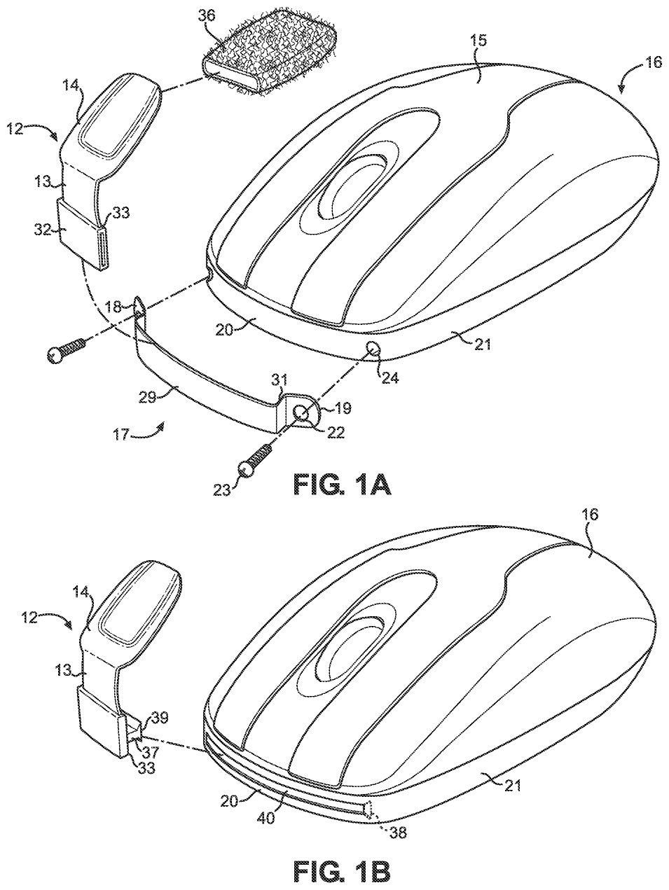

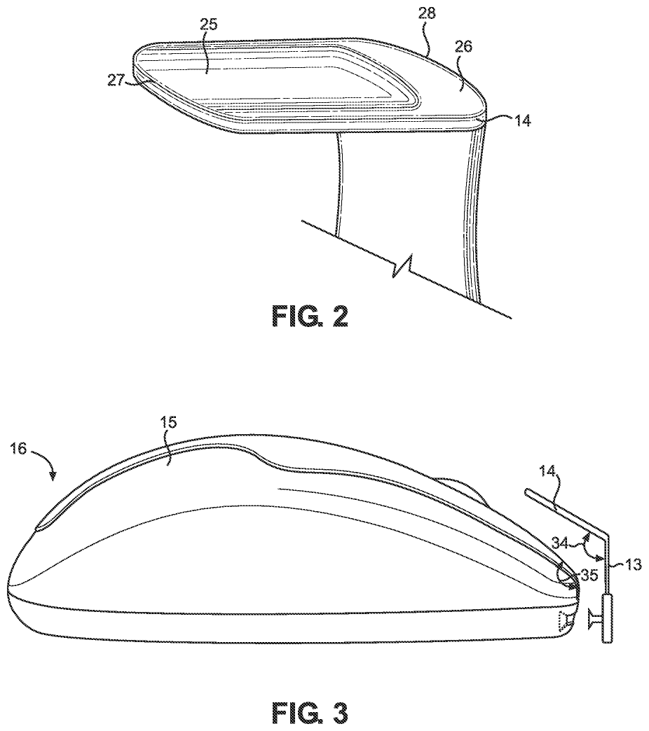

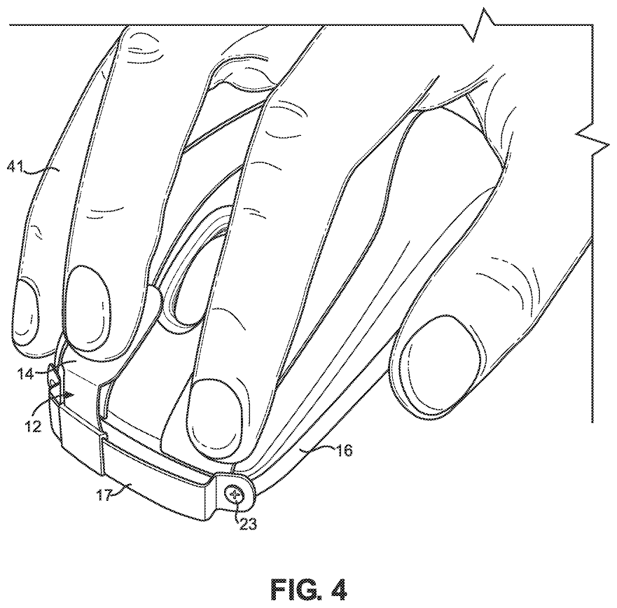

Referring now to FIG. 1A, there is shown an exploded view of an embodiment of the mouse finger rest. The mouse finger rest comprises a finger support 12 having a lower leg 13 affixed to an upper platform 14, wherein the upper platform 14 is disposed at an angle relative to the lower leg 13. In this manner, the upper platform 14 is configured to extend over an upper portion 15 of a mouse 16. The finger support 12 is contemplated to comprise a rigid structure such that the upper platform 14 does not flex upon the application of a weight of a user's finger, thereby preventing the user's finger from unintentionally actuating a mouse button. In the illustrated embodiment, a textured cover 36 comprises a sheath removably securable over the finger rest 12, such that the textured cover 36 extends over an entirety of the upper platform 14, such that the upper platform 14 is cushioned thereby. In this manner, the user can selectively affix the textured cover 36 to increase both comfort and frictional engagement with the finger rest 12 as desired. In some embodiments, the textured cover 36 comprises a plurality of flexible threads affixed to an exterior thereof providing a soft and comfortable material coating across the textured cover 36, however, in alternate embodiments, other cushioning materials such as gel cushions, rubber, or the like are contemplated.

In the illustrated embodiment, the finger support 12 is slidably affixed to a bracket 17 along a lower end 33 of the lower leg 13. In such embodiments, the bracket 17 is configured to removably secure to a front portion 20 of the mouse 16 along a base 21 thereof, such that the finger support 12 is slidably movable along a width of the mouse 16. In this manner, the user can selectively position the finger support 12 over a mouse button to prevent accidental actuation thereof, while also providing a location upon which a user can rest one or more fingers to prevent repetitive strain injuries over prolonged mouse 16 usage, such as carpal tunnel syndrome. In alternate embodiments, the lower leg 13 is rigidly and permanently affixed to the bracket 17 in a desired position, such that when the user wishes to utilize the finger support 12, the user can simply affix the bracket 17 to the mouse 16. In the shown embodiment, a loop 32 is affixed to the lower end 33 of the lower leg 13, wherein the loop 32 is dimensioned to slidably secure about a central portion 29 of the bracket 17. In some embodiments, the loop 32 is sized to be within a close tolerance to the central portion 29 of the bracket 17 such that the loop 32 frictionally engages the bracket 17 to retain the finger rest 12 in a desired position. In the shown embodiment, a first end 18 of the bracket 17 and a second end 19 of the bracket comprise an aperture 22 therethrough, wherein the apertures 22 are dimensioned to receive a fastener 23 therethrough. The fastener 23 in turn secures through a complementary aperture 24 disposed through the base 21 of the mouse 16, such that the bracket 17 is removably secured thereto. Furthermore, in the shown embodiment, the central portion 29 of the bracket 17 is maintained at a distance from the front side 20 of the mouse 16 via perpendicular extensions 31 disposed between the first and second ends 18, 19 of the bracket 17 and the central portion 29 of the bracket 17. This arrangement defines a gap between the central portion 29 and the front portion 20 of the mouse 16, wherein the gap facilitates movement of the finger support 12 along the bracket 17. Furthermore, the offset defining the gap allows a wire extending from the mouse 16 to pass unimpeded therethrough.

Referring now to FIG. 1B, there is shown an exploded view of an alternate embodiment of the mouse finger rest. In the illustrated embodiment, the finger support 12 similarly comprises the lower leg 13 and the upper platform 14, however the finger support 12 is integrally affixed to the base 21 of the mouse 16 via a track 38 disposed through the front portion 20 of the mouse 16. The finger support 12 is slidably disposed within the track 38 via a protrusion 37 extending from the lower end 33 of the lower leg 13 of the finger support 12. In some embodiments, the protrusion 37 is dimensioned to frictionally engage within the track 38 to retain the finger support 12 in a desired position relative to the mouse 16. In the shown embodiment, the protrusion 37 is integrally retained within the track 38 via a distal end 39 of the protrusion 37, wherein the distal end 39 comprises a width greater than that of the remainder of the protrusion 37 as well as a track aperture 40 disposed across the front portion 20 of the mouse 16. In this manner, the distal end 39 of the protrusion 37 prevents the removal of the finger rest from the track 38 via forces perpendicular to the longitudinal axis of the track 38. In the shown embodiment, the cross-section of the track 38 contours to the cross-section of the protrusion 37, such that the track 38 frictionally engages the protrusion 37. In some embodiments, the track 38 extends through a lateral side of the mouse 16 to allow the user to remove the finger rest 12 therefrom.

Referring now to FIG. 2, there is shown a close-up view of a depression of an embodiment of the mouse finger rest. In the illustrated embodiment, a depression 25 is disposed within an upper surface 26 of the upper platform 14, wherein the depression 25 is dimensioned to receive one or more fingertips of the user therein. In this manner, the upper platform 14 more accurately conforms to the shape of a user's fingertip, thereby increasing comfort and preventing lateral shifting of the user's fingertip during mouse usage. As such, the fingertip is more securely retained on the upper platform 14 during use. In the shown embodiment, the depression 25 extends through a front end 27 of the upper platform 14, such that a height of the upper platform 14 at the front end 27 is less than a height of the upper platform 14 at a rear end 26 thereof. In this manner, the front end 27 does not impede the finger of the user, allowing the user's finger to rest substantially flat relative to the upper platform 14. In this manner, the user need not arch their finger to rest within the depression 25 during use, facilitating relaxation of the user's muscles to reduce strain over prolonged periods of use.

Referring now to FIG. 3, there is shown a side view of an embodiment of the mouse finger rest affixed to a mouse. In the illustrated embodiment, the upper platform 14 is maintained at an angle 34 relative to the lower leg 13, wherein the lower leg 13 is contemplated to rest substantially perpendicular to a support surface on which the mouse 16 is being utilized. A length of the lower leg 13 is further dimensioned to maintain the upper platform 14 in an elevated position over the upper portion 15 of the mouse 16. In this manner, the user's finger is maintained away from the upper portion 15 and the associated mouse buttons during use, such that the user does not unintentionally actuate the mouse buttons, while simultaneously providing a resting surface for a user's finger to reduce strain of prolonged mouse 16 activity. In the shown embodiment, the angle 34 between the upper platform 14 and the lower leg 13 is equivalent to a slope 35 of the upper portion 15 of the mouse, such that the upper platform 14 rests substantially parallel to the upper portion 15. In this manner, the user's finger position is relaxed in an elevated position similar to a traditional hand position when utilizing a mouse 16, thereby minimizing strain.

Referring now to FIG. 4, there is shown a perspective view of an embodiment of the mouse finger rest in use. In one use, the finger rest 12 is secured to the mouse 16 and positioned along a width of the mouse 16 until the upper platform 14 rests in a desired position over a mouse button or in a desired resting position. In the shown embodiment, the finger rest 12 is removably securable to the mouse 16 via affixing the bracket 17 to the front portion of the mouse 16 via fasteners 23 inserted through the first and second ends of the bracket 17 and through complementary apertures within the front portion of the base of the mouse 16. Alternatively, the finger rest 12 can be integral with the front portion of the mouse 16 via the track as previously described, allowing a user to position the upper platform 14 as desired. Once the upper platform 14 is in a desired position, the user can rest a finger 41 on the upper platform 14 to reduce strain and minimize the risk of unintentionally actuating a mouse button. In this manner, the user is provided with a movable means for supporting a finger over the upper portion of the mouse 16 for extended periods.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A mouse finger rest, comprising:
a finger support having a lower leg and an upper platform;
wherein the upper platform is rigidly affixed to the lower leg at an angle to rest substantially parallel to an upper portion of a mouse;
wherein the lower leg is disposed along a bracket;
wherein a first end of the bracket and a second end of the bracket are removably securable to a front portion of a base of the mouse.

2. The mouse finger rest of claim 1, wherein a pair of apertures are disposed through the first end and the second end of the bracket, the apertures dimensioned to receive fasteners therethrough.

3. The mouse finger rest of claim 2, wherein the fasteners removably secure the bracket to corresponding apertures disposed within the base of the mouse.

4. The mouse finger rest of claim 1, further comprising a depression disposed within an upper surface of the upper platform, wherein the depression is dimensioned to contour to a fingertip.

5. The mouse finger rest of claim 4, wherein the depression extends through a front end of the upper platform, such that the front end comprises a height less than that of a rear end of the upper platform.

6. The mouse finger rest of claim 1, wherein the first end and the second end of the bracket are offset from a central portion of the bracket, such that a gap is defined between the front portion of the mouse and the central portion.

7. The mouse finger rest of claim 6, wherein the first and second ends are offset via a pair of extensions disposed perpendicularly to each of the central portion and the first and second ends.

8. The mouse finger rest of claim 1, wherein a loop is affixed to a lower end of the lower leg, wherein the loop is slidably disposed about the bracket.

9. The mouse finger rest of claim 8, wherein the loop is dimensioned to frictionally engage the bracket, such that the finger support is retained in a desired position.

10. The mouse finger rest of claim 1, wherein the angle is equivalent to a slope of the upper portion of the mouse.

11. The mouse finger rest of claim 1, wherein the bracket comprises an arcuate central portion.

12. The mouse finger rest of claim 1, further comprising a textured covering removably securable over the finger support.

13. The mouse finger rest of claim 1, wherein a length of the lower leg maintains the upper platform in an elevated state above the upper portion of the mouse.

14. A mouse finger rest, comprising:
a finger support having a lower leg and an upper platform;
wherein the upper platform is rigidly affixed to the lower leg at an angle to rest substantially parallel to an upper portion of a mouse;
a protrusion extending perpendicularly from a lower end of the lower leg;
wherein the protrusion is slidably disposed within a track disposed in a front portion of a base of a mouse.

15. The mouse finger rest of claim 14, wherein the protrusion comprises a distal end having a height greater than a height of a track aperture.

16. The mouse finger rest of claim 14, further comprising a depression disposed within an upper surface of the upper platform, wherein the depression is dimensioned to contour to a fingertip.

17. The mouse finger rest of claim 16, wherein the depression extends through a front end of the upper platform, such that the front end comprises a height less than that of a rear end of the upper platform.

18. The mouse finger rest of claim 14, wherein the angle is equivalent to a slope of the upper portion of the mouse.

19. The mouse finger rest of claim 14, further comprising a textured covering removably securable over the finger support.

20. The mouse finger rest of claim 14, wherein a length of the lower leg maintains the upper platform in an elevated state above the upper portion of the mouse.
